(19) United States
(12) Patent Application Publication
(10) Pub. No.: US 2010/0167175 A1
(43) Pub. Date: Jul. 1, 2010

(54) ELECTROCHEMICAL CATALYSTS

(75) Inventors: Robert Brian Dopp, Marietta, GA (US); Kimberly McGrath, Newport Beach, CA (US); R. Douglas Carpenter, Tustin, CA (US)

Correspondence Address: KNOBBE MARTENS OLSON & BEAR LLP, 2040 MAIN STREET, FOURTEENTH FLOOR, IRVINE, CA, 92614, US

(73) Assignee: QUANTUMSPHERE, INC., Santa Ana, CA (US)

(21) Appl. No.: 12/724,848

(22) Filed: Mar. 16, 2010

Related U.S. Application Data
(62) Division of application No. 11/482,290, filed on Jul. 7, 2006.
Application No. 11/482,290 is a continuation-in-part of application No. 11/254,629, filed on Oct. 20, 2005.

(51) Int. Cl. B01J 23/10; H01M 4/02; C25B 11/04; H01M 8/04; C25B 11/03

(52) U.S. Cl. 429/516; 502/302; 502/300; 429/523; 429/209; 204/292; 204/283

(57) ABSTRACT

A composition useful in electrodes provides higher power capability through the use of nanoparticle catalysts present in the composition. Nanoparticles of transition metals are preferred such as manganese, nickel, cobalt, iron, palladium, ruthenium, gold, silver, and lead, as well as alloys thereof, and respective oxides. These nanoparticle catalysts can substantially replace or eliminate platinum as a catalyst for certain electrochemical reactions. Electrodes, used as anodes, cathodes, or both, using such catalysts have applications relating to metal-air batteries, hydrogen fuel cells (PEMFCs), direct methanol fuel cells (DMFCs), direct oxidation fuel cells (DOFCs), and other air or oxygen breathing electrochemical systems as well as some liquid diffusion electrodes.

### CROSS-REFERENCE TO RELATED APPLICATIONS

This application is a divisional of U.S. patent application Ser. No. 11/482,290, filed Jul. 7, 2006, which is a continuation-in-part of U.S. patent application Ser. No. 11/254,629, filed Oct. 20, 2005, the contents of each of which are incorporated herein by reference.

### BACKGROUND OF THE INVENTION

1. Technical Field

This disclosure generally relates to catalytic compositions comprising nanoparticles of metals, alloys, and/or oxides thereof, and more particularly, to electrodes comprising the nanoparticles useful as high performance diffusion electrodes in electrochemical devices, for example, metal-air batteries, direct methanol fuel cells (DMFCs), proton exchange membrane fuel cells (PEMFCs), alkaline fuel cells, and sensing devices.

2. Related Art

Platinum is highly catalytic for oxygen reduction in gas diffusion electrodes for fuel cells and metal-air batteries. However, platinum is expensive and in limited supply. A current price for bulk platinum black is about $75.00/gram. The associated cost of a platinum catalyst electrode, typically loaded with platinum black at a rate of from 2-8 mg/cm² of surface area in a fuel cell, metal-air battery, or other practical power-generating device, can be an obstacle to the widespread commercial acceptance of such devices. With the growing demand for power sources such as fuel cells and air batteries for portable devices and vehicles, efficient catalysts replacing platinum in such applications are highly desirable. Consequently, considerable effort has been dedicated to finding alternative catalysts that match or exceed platinum's performance at a lower cost.

### SUMMARY OF THE INVENTION

Some disclosed embodiments allow the use of lower cost materials as catalysts in electrodes, for example, manganese, nickel, cobalt, silver, alloys thereof, and their respective oxides, for the reduction of oxygen in air breathing systems, and oxidation of hydrogen or hydrocarbon fuels. Chromium, ruthenium, palladium, lead, iron, gold, and their associated alloys and oxides, among other metals, are also useful in some embodiments.

In a first aspect, a composition is provided that comprises a plurality of reactive metal particles; and (b) a substrate. Preferably, the substrate comprises a plurality of highly porous particles that have both a high internal and external surface area and more preferably is porous carbon with a high internal and external surface area. The composition may also comprise carbon such as carbon derived from coal or activated carbon particles, or the carbon may be a solid mass of porous carbon or a sheet of porous carbon.

In certain embodiments, it is preferable that the composition of metal particles and carbon be maintained in an inert environment, preferably in an inert gas environment such as argon, such that the rate of reaction can be specifically controlled by reagents, without reaction with air. However, in certain embodiments wherein a less reactive metal composition is employed, it can be acceptable or even desirable to maintain the composition in ambient atmosphere (e.g., air). In addition, it is preferable that the substrate have affinity with the reactive metal particles such that the metal particles are absorbed onto both the internal and external surface of the substrate. In addition, this substrate material is capable of adhering the reactive metal particles to its internal and external surfaces to form a coherent mass that maintains its high reactivity. In certain environments, it can be acceptable to have only adsorption of the metal particles onto an external surface of a substrate (e.g., a non-porous substrate).

The composition of reactive metal particles and substrate can further comprise a polymeric material capable of binding a substantial portion of the highly porous particles. Most preferably, this material is a fluorocarbon.

In another embodiment, the composition which comprises reactive metal particles, a highly porous substrate and a binding material can be used as an electrical component, e.g., an electrode. Use of reactive metal particles increases the performance of electrochemical cells such as a variety of batteries and fuel cells, which equates to an increased amount of available energy available for the end user. In addition, these electrodes can also be used as electrodes in liquid diffusion systems, which can also increase electrochemical cell power and/or longevity.

Preferably, the reactive metal or metals that comprise the nanoparticles are transition metals, more preferably selected from the group of metals of groups 3-16, the lanthanide series, mixtures thereof, and alloys thereof. Most preferably, the metal or metals are selected from the group consisting of manganese, cobalt, nickel, and silver or combinations thereof.

In preferred embodiments, the reactive metal particles comprise an oxide of the metal or alloy. The nanoparticles can have oxide shell, for example an oxide shell comprising less than 70 wt. % of the total weight of the particle. In other embodiments, the particles can be oxidized and consist entirely or partially of an oxide of the metal or alloy.

The reactive metal particles have a diameter of less than 1000 nm. Such particles are generally referred to as “nanoparticles.” Preferably the nanoparticles have diameters of less than about 100 nm, more preferably less than about 25 nm, or even more preferably less than about 10 nm.

Electrodes can be formed from the compositions of the preferred embodiments. In one embodiment, the electrode is a compressed mixture of the fluorocarbon, the carbon, and the nanoparticles. Further, the electrode can have first and second sides, and can further comprise a hydrophobic layer bonded to the first side of the electrode. The electrode can further comprise a current collector, which can be laminated thereto.

Another embodiment is directed to a method of making the electrode, comprising mixing carbon in a fluid environment (e.g., aqueous, methanolic, or the like) to form a mixture; adding the fluorocarbon to the mixture; removing the fluid from the fluorocarbon-containing mixture; blending the dried fluorocarbon-containing mixture with the nanoparticles, optionally in the presence of a light alcohol, preferably methanol, to form a blended mixture; and compressing the blended mixture to form the electrode. The method can further comprise laminating the electrode with a current collector. A preferred electrode is a gas diffusion air cathode comprising a compressed mixture of activated carbon particles; nanoparticles comprising a metal, alloy and/or an oxide of the metal or alloy; a fibrillated fluorocarbon; and an internal current collector.

In yet another embodiment, the a fuel cell containing such an electrode is provided.

Some embodiments provide a composition suitable for use in at least one electrochemical or catalytic application, the composition comprising a plurality of reactive metal particles and at least one substrate that has lesser reactivity than the reactive metal particles and that has a substantially high surface area relative to its volume, wherein at least a portion of a surface of the substrate comprises an interior surface within an outer dimension of the substrate, and wherein at least a portion of the reactive metal particles reside proximate to a portion of the interior surface.

In some embodiments, the composition is capable of being maintained in a sufficiently stable environment to permit controlled oxidation of at least a portion of the plurality of reactive metal particles.

In some embodiments, the substrate comprises a material having affinity for the reactive metal particles such that when the reactive particles are brought into contact with the substrate the particles may become associated with the substrate. In some embodiments, the substrate consists essentially of a binder capable of adhering at least a significant portion of the plurality of reactive metal particles into a substantially structurally coherent mass without significantly impacting the reactivity of a substantial number of the reactive metal particles. the substrate is highly porous. In some embodiments, the substrate comprises a plurality of highly porous particles. the substrate comprises carbon.

Some embodiments further comprise a binder for adhering at least a substantial portion of the plurality of highly porous particles. In some embodiments, the binder comprises a polymeric material. In some embodiments, the polymeric material comprises a fluorocarbon.

In some embodiments, at least a substantial portion of the plurality of reactive metal particles comprises nanoparticles having a diameter of less than about one micrometer. In some embodiments, the nanoparticles comprise particles having a diameter of less than about 100 nm. In some embodiments, the nanoparticles comprise particles having a diameter of less than about 50 nm. In some embodiments, the nanoparticles comprise particles having a diameter of less than about 25 nm. In some embodiments, the nanoparticles comprise particles having a diameter of less than about 10 nm.

In some embodiments, at least a portion of the nanoparticles comprises nanoparticles having an oxide shell. In some embodiments, the plurality of reactive metal particles comprises a metal selected from the group consisting of metals from groups 3-16, lanthanides, combinations thereof, and alloys thereof.

Some embodiments further comprise a catalyst to enhance the catalytic activity of said composition.

Some embodiments provide an electrochemical component comprising a composition suitable for use in at least one electrochemical or catalytic application, the composition comprising a plurality of reactive metal particles and at least one substrate that has lesser reactivity than the reactive metal particles and that has a substantially high surface area relative to its volume, wherein at least a portion of a surface of the substrate comprises an interior surface within an outer dimension of the substrate, and wherein at least a portion of the reactive metal particles reside proximate to a portion of the interior surface. In some embodiments, said component is coupled to a current collector for providing a portion of a circuit that is configured to permit an electrical connection between said component and a second component to transmit current therebetween.

Some embodiments provide an electrode comprising the above circuit portion suitable for use in an electrical energy generating device whereby energy may be provided in a controlled fashion. Some embodiments further comprise a hydrophobic membrane disposed on a face thereof, wherein the membrane is configured to inhibit passage therethrough of water generated by electrochemical reaction of protons and oxygen in the device. In some embodiments, the electrode is a gas diffusion electrode.

Some embodiment provide a fuel cell comprising a composition suitable for use in at least one electrochemical or catalytic application, the composition comprising a plurality of reactive metal particles and at least one substrate that has lesser reactivity than the reactive metal particles and that has a substantially high surface area relative to its volume, wherein at least a portion of a surface of the substrate comprises an interior surface within an outer dimension of the substrate, and wherein at least a portion of the reactive metal particles reside proximate to a portion of the interior surface, wherein the fuel cell is configured to consume a fuel whereby electricity is generated.

Some embodiments provide a hydrogen generator comprising a composition suitable for use in at least one electrochemical or catalytic application, the composition comprising a plurality of reactive metal particles and at least one substrate that has lesser reactivity than the reactive metal particles and that has a substantially high surface area relative to its volume, wherein at least a portion of a surface of the substrate comprises an interior surface within an outer dimension of the substrate, and wherein at least a portion of the reactive metal particles reside proximate to a portion of the interior surface, wherein the hydrogen generator is configured to electrolyze water to yield oxygen and hydrogen.

Some embodiments provide a sensor comprising a composition suitable for use in at least one electrochemical or catalytic application, the composition comprising a plurality of reactive metal particles and at least one substrate that has lesser reactivity than the reactive metal particles and that has a substantially high surface area relative to its volume, wherein at least a portion of a surface of the substrate comprises an interior surface within an outer dimension of the substrate, and wherein at least a portion of the reactive metal particles reside proximate to a portion of the interior surface, wherein the sensor is configured to detect a presence of a gas.

Some embodiments provide an electrochemical sensor comprising a composition suitable for use in at least one electrochemical or catalytic application, the composition comprising a plurality of reactive metal particles and at least one substrate that has lesser reactivity than the reactive metal particles and that has a substantially high surface area relative to its volume, wherein at least a portion of a surface of the substrate comprises an interior surface within an outer dimension of the substrate, and wherein at least a portion of the reactive metal particles reside proximate to a portion of the interior surface, wherein the sensor is configured to detect an analyte capable of undergoing an electrochemical reaction at the sensor. In some embodiments, the electrochemical sensor is a bio sensor.

Some embodiments provide a method for manufacturing a composition suitable for use in at least one electrochemical or catalytic application, the composition comprising a plurality of reactive metal particles and at least one substrate that has lesser reactivity than the reactive metal particles and that has a substantially high surface area relative to its volume, wherein at least a portion of a surface of the substrate comprises an interior surface within an outer dimension of the substrate, and wherein at least a portion of the reactive metal particles reside proximate to a portion of the interior surface. The method comprises contacting, in a substantially anoxic fluid, the plurality of reactive metal particles and the substrate.

In some embodiments, the fluid exhibits an affinity for the reactive metal particles and the substrate. In some embodiments, the substrate comprises a plurality of highly porous particles. In some embodiments, the fluid provides for a substantially uniform dispersion of the reactive metal particles and the highly porous particles to optimize mixing. In some embodiments, the fluid comprises a lower alcohol.

Some embodiments further comprise exposing at least a substantial portion of the reactive metal particles to an oxidizing environment so as to permit controlled oxidation of the substantial portion.

Some embodiments further comprise separating the fluid from the reactive metal particles and the substrate.

Some embodiments provide a composition suitable for use in an electrochemical application, the composition comprising a composite of a plurality of metal nanoparticles and a binding material that is substantially inert under conditions of the at least one electrochemical application, wherein the metal nanoparticles are bound together by the binding material in a manner sufficient to leave a substantial portion of surface area of a substantial portion of the nanoparticles exposed, such that the exposed surface area is available for catalyzing a reaction in the at least one electrochemical application.

In some embodiments, the nanoparticles comprise particles having an effective size less than about 100 nm. In some embodiments, the nanoparticles comprise particles having an effective size less than about 50 nm. In some embodiments, the nanoparticles comprise particles having an effective size less than about 25 nm. In some embodiments, the nanoparticles comprise particles having an effective size less than about 10 nm.

In some embodiments, at least a portion of the nanoparticles comprises nanoparticles having an oxide shell. In some embodiments, the plurality of nanoparticles comprises a metal selected from the group consisting of metals from groups 3-16, lanthanides, combinations thereof, and alloys thereof.

In some embodiments, the binding material comprises a polymeric material. In some embodiments, the polymeric material comprises a fluorocarbon.

Some embodiments further comprise a catalyst to enhance the catalytic activity of said composition.

Some embodiments provide an electrochemical component comprising a composition suitable for use in an electrochemical application, the composition comprising a composite of a plurality of metal nanoparticles and a binding material that is substantially inert under conditions of the at least one electrochemical application, wherein the metal nanoparticles are bound together by the binding material in a manner sufficient to leave a substantial portion of surface area of a substantial portion of the nanoparticles exposed, such that the exposed surface area is available for catalyzing a reaction in the at least one electrochemical application. In some embodiments, said component is coupled to a current collector for providing a portion of a circuit that is configured to permit an electrical connection between said component and a second component to transmit current therebetween.

Some embodiments provide an electrode comprising the above circuit portion, suitable for use in an electrical energy generating device whereby energy may be provided in a controlled fashion. Some embodiments of the electrode further comprise a hydrophobic membrane disposed on a face thereof, wherein the membrane is configured to inhibit passage therethrough of water generated by electrochemical reaction of protons and oxygen in the device. In some embodiments, the electrode is a diffusion electrode.

Some embodiments provide a fuel cell comprising a composition suitable for use in an electrochemical application, the composition comprising a composite of a plurality of metal nanoparticles and a binding material that is substantially inert under conditions of the at least one electrochemical application, wherein the metal nanoparticles are bound together by the binding material in a manner sufficient to leave a substantial portion of surface area of a substantial portion of the nanoparticles exposed, such that the exposed surface area is available for catalyzing a reaction in the at least one electrochemical application, wherein the fuel cell is configured to consume a fuel whereby electricity is generated.

Some embodiments provide a hydrogen generator comprising a composition suitable for use in an electrochemical application, the composition comprising a composite of a plurality of metal nanoparticles and a binding material that is substantially inert under conditions of the at least one electrochemical application, wherein the metal nanoparticles are bound together by the binding material in a manner sufficient to leave a substantial portion of surface area of a substantial portion of the nanoparticles exposed, such that the exposed surface area is available for catalyzing a reaction in the at least one electrochemical application, wherein the hydrogen generator is configured to electrolyze water to yield oxygen and hydrogen.

Some embodiments provide a sensor comprising a composition suitable for use in an electrochemical application, the composition comprising a composite of a plurality of metal nanoparticles and a binding material that is substantially inert under conditions of the at least one electrochemical application, wherein the metal nanoparticles are bound together by the binding material in a manner sufficient to leave a substantial portion of surface area of a substantial portion of the nanoparticles exposed, such that the exposed surface area is available for catalyzing a reaction in the at least one electrochemical application, wherein the sensor is configured to detect a presence of a gas.

Some embodiments provide an electrochemical sensor comprising a composition suitable for use in an electrochemical application, the composition comprising a composite of a plurality of metal nanoparticles and a binding material that is substantially inert under conditions of the at least one electrochemical application, wherein the metal nanoparticles are bound together by the binding material in a manner sufficient to leave a substantial portion of surface area of a substantial portion of the nanoparticles exposed, such that the exposed surface area is available for catalyzing a reaction in the at least one electrochemical application, wherein the sensor is configured to detect an analyte capable of undergoing an electrochemical reaction at the sensor.

Some embodiments provide a composition suitable for use in at least one electrochemical or catalytic application, the composition comprising a plurality of reactive particles and at least one substrate that has lesser reactivity than the reactive particles and that has a substantially high surface area relative to its volume, wherein at least a portion of a surface of the substrate comprises an interior surface within an outer dimension of the substrate, and wherein at least a portion of the reactive particles reside proximate to a portion of the interior surface, wherein the reactive particles comprise a metal oxide.

Some embodiments provide nanoparticles disposed on a means for supporting the nanoparticles, wherein the nanoparticles comprise at least one of a metal, an alloy of the metal, or an oxide of the metal. The nanoparticles have effective of sizes less than about 100 nm, less than about 50 nm, less than about 25 nm, or less than about 10 nm with standard deviations of less than about 4 nm or less than about 2 nm. In some embodiments, the metal is selected from groups 3-16 and the lanthanides. In some embodiments, the support comprises a high-surface area support, for example, carbon. In some embodiments, the support comprises a fluorinated polymer.

### BRIEF DESCRIPTION OF THE DRAWINGS

FIG. 1 is a transmission electron microscopy (TEM) photograph of nickel nanoparticles comprising an oxide shell.

FIG. 2 is a schematic diagram of a composition comprising activated carbon and polytetrafluorethylene (PTFE) particles prior to milling.

FIG. 3 is a schematic diagram of a composition comprising activated carbon and polytetrafluorethylene (PTFE) particles subsequent to milling.

FIG. 4 is a schematic diagram of a gas electrode.

FIG. 5 is a plot of cell voltage/current characteristics of embodiments of cathodes comprising compositions of preferred embodiments.

FIG. 6 is a bar graph illustrating the mid Tafel CCV of five cathode designs: Design 1 comprises NORIT® Supra carbon with no added catalyst; Design 2 comprises Darco® G-60 carbon with no added catalyst; and Design 3 comprises NORIT® Supra carbon with 10 weight percent manganese nanoparticles comprising oxide shells; and Design 4 comprises Darco® G-60 carbon with 10 weight percent manganese nanoparticles comprising an oxide shell; and Design 5 comprises nearly 8 mg/cm² loading of platinum powder.

FIG. 7 is a bar graph displaying the data of FIG. 6 as a percentage of the performance of the platinum catalyzed cathode.

FIG. 8 illustrates a full Voltammogram of the electrodes depicted in FIG. 6.

### DETAILED DESCRIPTION OF SOME PREFERRED EMBODIMENTS

Compositions of preferred embodiments can comprise supported nanoparticles. As discussed in greater detail below, in some embodiments, the nanoparticles comprise metals, metal alloys, oxides thereof, and combinations thereof. The support can comprise at least one binder, a high-surface-area substrate, and combinations thereof. Exemplary binders are discussed in greater detail below. The compositions of preferred embodiments are useful in the manufacture of electrodes, which are incorporated, for example, into electrochemical cells, batteries, fuel cells, sensors, and the like. As used herein, the term “reactive” refers to species that participate in chemical reactions, either as stoichiometric reagents, or as catalysts.

Compositions of preferred embodiments can comprise nanoparticles supported by a binder, for example, a fluorocarbon, with a relative proportion of from about 1% to about 98% nanoparticles and from about 4% to about 20% binder by weight of the composition, preferably from about 1% to about 95% nanoparticles and from about 5% to about 8% binder.

Other compositions of preferred embodiments can comprise nanoparticles supported on a high-surface-area substrate. In some embodiments, the substrate is electrically conductive, comprising, for example, carbon, graphite, carbon nanotubes, combinations thereof, and the like. The compositions can further comprise a binder and, optionally, a base catalyst. In some embodiments, the composition comprises nanoparticles, binder, substrate, and base catalyst with relative proportions of from about 1% to about 10% nanoparticles, from about 4% to about 20% binder, from about 20% to about 90% substrate, and from about 0% to about 15% base catalyst by weight of the total weight of the composition. In some embodiments, the composition comprises from about 1% to about 5% nanoparticles, from about 5% to about 8% binder, from about 87% to about 94% substrate, and from about 0% to about 15% base catalyst (by weight of the total weight of the composition).

Historically, platinum has been the best performing catalyst in a wide variety of fuel cells and batteries, and until now platinum was the only practicable catalyst for high power hydrogen and direct methanol fuel cell cathodes. The demand for fuel cells, hydrogen electrolysis and other non-petroleum based energy sources could conceivably consume all of the world's production of platinum. By virtue of their increased surface areas, nanoparticles of the preferred embodiments, such as those of nickel, cobalt and other transition elements, along with their alloys and corresponding oxides thereof, exhibit increased catalytic activity, and are promising platinum replacement candidates for a variety of battery and fuel cell applications.

Nanoparticles can be used to replace and/or supplement platinum or other catalysts in electrodes, for example, in fuel cell or battery cathodes. In some preferred embodiments, the nanoparticles comprise a metal, a metal alloy, an oxide thereof, or combinations thereof. In some embodiments, the metal is selected from the group including transition metals of groups 3-16, lanthanides, and mixtures combinations, and/or alloys thereof. More preferably, the metal is selected from groups 7, 8, 9, 10, 11, and the lanthanides. Preferred embodiments include nanoparticles of metals, metal alloys, and the oxides thereof that are at least nearly as active as platinum for a reduction of oxygen in at least one electrolyte environment of commercial or other (e.g., research) significance, for example, manganese, nickel, cobalt, and/or silver. Embodiments of nanoparticles of manganese and manganese alloys comprising an oxide thereof exhibit significant performances relative to platinum.

As used herein, the term “nanoparticle” refers to a particle with a maximum dimension of from about 1 to about 999 nm (10⁻⁹ meters). Because the particles are generally spherical in some embodiments, this dimension is also referred to herein as the “effective diameter” of a particle, although other shapes are also observed. The number of atoms comprising a nanoparticle rapidly increases as nanoparticle size increases from ones to hundreds of nanometers. Roughly, the number of atoms increases as a function of the cube of the particle's effective diameter. Nickel nanoparticles, for example, have about 34 atoms in a 1 nm particle, about 34 million atoms in a 100 nm particle, and about 34 billion in a 1 μm particle.

In preferred embodiments, the nanoparticles include metal nanoparticles, metal alloy nanoparticles, metal and/or metal alloy nanoparticles comprising an oxide shell, nanoparticles that are substantially or completely an oxide of the metal and/or metal alloy, or mixtures thereof. Preferably, the nanoparticles have a diameter of less than about 1 μm, less than about 100 nm, more preferably less than about 50 nm, even more preferably less than about 25 nm, and most preferably less than about 10 nm. In some embodiments, the standard deviation of the nanoparticle diameter distribution is less than about 4 nm, preferably less than about 2 nm. The use of the prefix “n” or “nano” before a material indicates that the material is nanoparticulate.

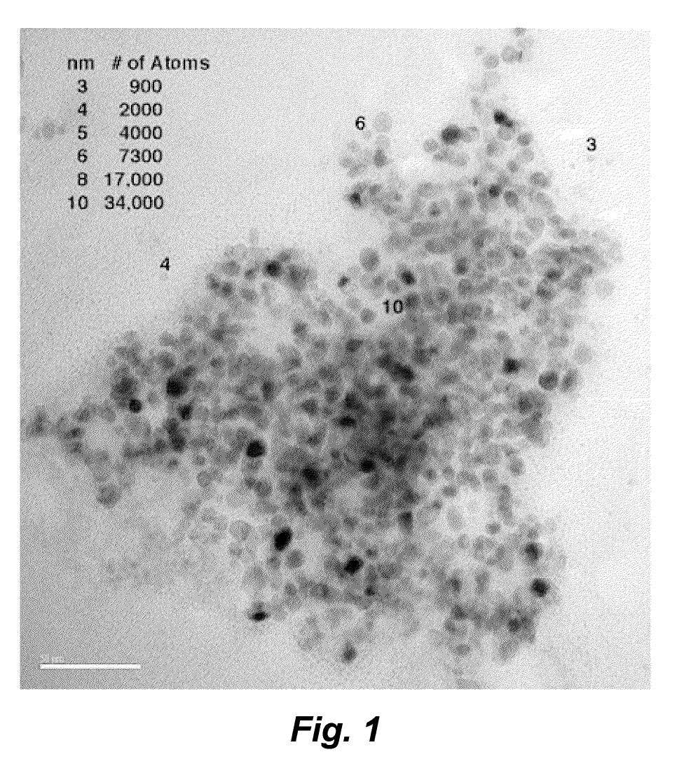

By virtue of their high surface area to volume ratio, nanoparticles exhibit improved catalytic activity relative to larger particles with comparable material compositions. Consequently, when a metal, metal alloy, and/or oxide particle diameter is on the nano-scale, associated catalytic properties are dramatically enhanced in some embodiments. The preparation of such nanoparticle catalysts has been described, for example, in U.S. application Ser. No. 10/840,409, filed May 6, 2004, and U.S. application Ser. No. 10/983,993, filed Nov. 8, 2004, the contents of which are incorporated herein by reference in their entireties. FIG. 1 is a transmission electron microscopy (TEM) photograph of a nickel nanoparticle catalyst, prepared as described above, illustrating size uniformity of the nanoparticles. Some of the illustrated nanoparticles are generally spherical with diameters of just a few hundred atoms.

In some embodiments, nanoparticles comprise an alloy, the alloy preferably comprises two or more metals, wherein preferably wherein at least one of the metals discussed above. Some embodiments of the alloy can comprise two, three, four or more metals. The ratio of metals in the alloy can be adjusted depending on the particular application. In some embodiments, one metal of the alloy comprises from about 5% to about 95% by weight of the alloy. In some embodiments, one metal comprises more than about 10% by weight, or more than about 25% by weight, of the alloy. In some embodiments, one metal comprises up to about 90% by weight of the alloy.

Preferred embodiments of the nanoparticles comprise an oxide shell and/or layer. This oxide shell can preferably comprise up to about 70% of the total weight of the nanoparticle, and depending on the particle size, the layer can have a thickness of from about 0.1 nm to greater than about 25 nm, preferably from about 0.1 to about 10 nm. It is believed that the oxide shell can provide one or more functions, such as aiding the catalytic reaction, imparting stability, and/or reducing particle agglomeration. A plurality of oxide species can be employed, for example, oxides of different oxidation states, allotropes, crystal forms, solvates, combinations and the like. The amount of the oxide shell of the nanoparticles can be adjusted based on the application. For example, the oxide shell can comprise less than about 70%, less than about 60%, less than about 50%, less than about 40%, less than about 30%, less than about 10%, or less than about 5% by weight of the nanoparticle. In some embodiments, the nanoparticles are produced by vapor condensation in a vacuum chamber; however, other methods for forming nanoparticles as are known in the art can also be employed. The oxide thickness can be controlled by introduction of air or oxygen into the chamber as the particles are formed. In some embodiments, the nanoparticles in the final device, for example, an electrode, are substantially or entirely oxidized; that is, substantially all of the metal or metal alloy has been converted to the corresponding oxide. In other embodiments, the alloy comprises a first metal that is susceptible to oxidation and a second metal that is resistant to oxidation. Partial or complete oxidation of such particles results in unoxidized or partially oxidized domains of the second metal dispersed in oxide of the first metal.

In some preferred embodiments, the nanoparticles comprise a metal and/or metal alloy core, for example, manganese, at least partially covered by an outer oxide layer or shell. In some embodiments, the metal is oxidized by exposure to air resulting in nanoparticles comprising the oxide of the metal and/or or metal alloy. Other oxidants known in the art are also useful, for example, O₂, O₃, and nitrogen oxides (e.g., NₓO_{y}, where x=1-2 and y=1-5). Other oxidants provide other oxidation products. For example, halogens provide metal halides rather than metal oxides, and halogen oxides provide metal oxyhalides, and/or mixtures of metal oxides and metal halides. Mixtures of oxidants are also useful.

Some embodiments of the oxidation are controllable to provide oxide shells of varying thicknesses, up to complete oxidation. In some preferred embodiments, nanoparticles comprising an oxide shell are adsorbed on a high-surface area substrate (or a metal and/or metal alloy core with dimensions) and then the nanoparticles are oxidized in situ. Embodiments of this oxidation process can provide compositions exhibiting improved electrode performance compared with compositions in which the nanoparticles are oxidized before adsorption. In some preferred embodiments, the nanoparticles comprise manganese, although other metal or metal alloy nanoparticles can be used in the in situ oxidation process to provide nanoparticles of the oxide of the metal or metal alloy. For example, nanoparticles comprising manganese and/or silver can be used, for example, under alkaline conditions. Nanoparticles comprising cobalt can also be used, for example, under acid conditions. It is believed that the small sizes of the nanoparticles provide at least some of the observed advantages because the very large surface area of these particles provides both increased reaction surface as well as a greater density of reactive sites. Without being bound by theory, it is believed that the nanoparticles comprising an oxide shell are more easily distributed in the carbon, compared to nanoparticles comprising substantially all metal oxide.

Moreover, the in situ oxidation permits controlled synthesis of a desired crystal form or allotrope of the metal oxide in some embodiments. For example, the controlled oxidation of supported manganese nanoparticles as described below is believed to provide principally β-manganese(II) oxide rather than γ-manganese(II) oxide, which is the principal product in the reduction of MnO₄⁻. β-Manganese(II) oxide is a superior electrode catalyst.

The binder, if employed, can comprise any suitable material known in the art, such as organic materials, monomers, polymers, copolymers, blends, combinations, and the like. In some preferred embodiments, the binder comprises a fluorocarbon. Fluorocarbons of preferred embodiments can include suitable monomeric and/or polymeric compounds comprising carbon and fluorine that can function as a binder. In preferred embodiments, the fluorocarbon comprises particles and/or fiber-like structures (“fibrillated”). In some embodiments, the binder is provided as a suspension in a suitable fluid. Preferably, the binder comprises from about 1% to about 20% of the total weight of the mixture of nanoparticles, substrate, and binder. In some embodiments, the particle size of the fluorocarbon is from about 0.3 μm to about 10 μm; however, in certain embodiments, larger and/or smaller particle sizes can be acceptable or even desirable. Suitable fluorocarbon polymers or fluorinated polymers include polytetrafluoroethylene (PTFE, Teflon®, DuPont), poly(vinylidine fluoride), substituted copolymers, combinations, and the like. Commercially available examples of suitable fluorocarbon emulsions include Teflon® 30b, Teflon® 30N, and Teflon® TE-3857, all from DuPont (Wilmington, Del.). Suitable powdered fluorocarbon binders include Teflon® 6c and Teflon® 7a (DuPont, Wilmington, Del.). Suitable substituted copolymers include sulfonated tetrafluoroethylene copolymers, for example, Nafion® (DuPont, Wilmington, Del.). In some embodiments, the fluorocarbons described above can be used interchangeably, although in other embodiments specific formulations are used, for example, for purposes of illustration.

Preferred high-surface-area substrates include carbon particles, for example, particles derived from coal, and/or activated carbon particles. In some preferred embodiments, the carbon particles have diameters of from about 5 nm to about 1 μm; however, other dimensions can also be employed in certain embodiments. Some preferred embodiments utilize high surface area carbon particles with large internal surface areas, e.g., about 500-2000 m²/g. Such particles can comprise a multiplicity of pores, and commercially available examples include Darco® G-60 (American Norit Corp.), which comprises activated carbon particles, wherein more than 90% of the particles have diameters of from about 5.5 μm to about 125 μm and wherein the internal surface area is about 1000 m²/g. As discussed in greater detail below, in some embodiments, at least some of the nanoparticles are adsorbed in the pores of the substrate. In some embodiments, the substrate is less catalytically active than the nanoparticles.

Suitable base catalysts include manganese oxides and platinum. In some embodiments, at least a portion of the base catalyst is disposed within the pores of a porous substrate, for example, manganese oxide in activated carbon, fabricated, for example, by in situ reduction of MnO₄⁻ by activated carbon. In some embodiments, at least a portion of the base catalyst is present as discrete particles in admixture with the composition, for example, as micron-sized platinum particles. In some embodiments comprising a coal-based carbon compound, for example, as a substrate, the carbon compound itself acts as a base catalyst. It is believed that chelated iron and/or other transition metals derived from the organic precursors to the coal are present in the pores, which are a natural base catalyst.

In some embodiments, supported nanoparticulate compositions are prepared using a method comprising treatment of the substrate (e.g., activated carbon, alumina, silica gel, bentonite, clays, diatomaceous earth, synthetic and natural zeolites, magnesia, titania, ceramics, sol gels, polymeric materials, and combinations thereof), the fluorocarbon (e.g., Teflon®), and nanoparticles in a suitable fluid medium (e.g., a lower alcohol such as methanol). Optionally, the nanoparticles are then oxidized, as discussed above, for example, by removing the fluid medium, and contacting the nanoparticles with an suitable oxidant.

Such a method can be used to prepare, e.g., cathodes with the improved performance relative to non-treated cathode catalysts. The improved performance is believed to be a result of improved catalyst distribution, and more effective binding of the catalyst to the activated carbon support. As discussed above, in some embodiments, nanoparticles and a substrate, for example, activated carbon, are contacted in an anaerobic environment, under which the oxidation state of the nanoparticles is stable, for example, in embodiments in which the nanoparticles comprise a zero valent metal (with or without an oxide shell) that reacts with molecular oxygen. Controlled, in situ oxidation of the nanoparticles is performed, for example, by contacting the supported nanoparticles with a suitable oxidant, for example, molecular oxygen, as discussed above. In some embodiments, the nanoparticle and carbon are suspended in deoxygenated fluid, for example, a light alcohol such as methanol. It is believed that the method permits adsorption of the nanoparticles into the interior of the activated carbon supporting substrate. Adsorption is qualitatively observed during mixing as the nanoparticles are adsorbed into the carbon, as indicated by a decrease in the observed turbidity of the fluid. Additionally, in some embodiments, when a cathode comprising a composition of a preferred embodiment is exposed to electrolyte, loss of nanoparticles into the electrolyte is not observed. In contrast, in cases where the nanoparticles are not sufficiently adsorbed to carbon, for example, when using certain other deposition methods, the electrolyte becomes cloudy, indicating that the nanoparticles are being released from the substrate. Thus, a cathode comprising activated carbon and nanoparticles, wherein the nanoparticles are adsorbed into the activated carbon as described above, is preferred, such that the nanoparticles are retained in the cathode upon exposure to electrolyte.

In embodiments in which the supported composition does not comprise a substrate, the composition is fabricated by mixing the nanoparticles with the binder, an optional base catalyst, and an optional lubricant (e.g., lubricating carbon), then milling the resulting mixture. Optionally, the nanoparticles are oxidized after milling as discussed above.

Some electrodes manufactured using the nanoparticulate compositions of preferred embodiments comprise a layer of the nanoparticulate composition laminated to a current collector. The current collector comprises a conductive material, for example, carbon and/or a metal, thereby electrically coupling the nanoparticle composition to an electrical load. In some embodiments, the current collector comprises a metal, such as a transition metal, preferably nickel, nickel plated steel, and/or gold plated nickel, and most preferably nickel. Preferably the current collector has a large outer surface area, for example, a collector in the form of a metal and/or woven wire screen.

Electrodes of preferred embodiments can be employed as cathodes, anodes, or both. In one embodiment, the electrode is paired with a counter electrode for providing an electrochemical cell. The counter electrode is of any suitable type, for example, a metal electrode or a wire. For example, in a zinc/air battery, the anode is zinc metal, and the electrode is an air or oxygen breathing cathode. However, in a device such as a hydrogen or methanol fuel cell, the electrode is useful as an anode, at which hydrogen or methanol is consumed, or a cathode, at which air or oxygen is consumed, or both.

The electrodes of preferred embodiments can also provide alternatives to platinum electrodes as in diffusion cathodes for power production through the electrochemical reduction of oxygen. Such oxygen consuming cathodes exhibit numerous advantages, including high current output, high discharge voltage, and/or high current densities. Electrodes are described herein with reference to an alkaline fuel cell (AFC) system; However, those skilled in the art will understand that the disclosed electrodes are also useful in other applications, for example, those in which platinum is a known catalyst. Examples of such applications include direct methanol fuel cells (DMFCs), hydrogen fuel cells or proton exchange membrane fuel cells (PEMFCs), and metal-air batteries, and other fuel cells. Hydrogen is oxidized at the anode of a hydrogen fuel cell, and methanol is oxidized at the anode of a methanol fuel cell.

In some embodiments, the electrodes are useful as sensors, for example, in electrochemical hydrogen sensors. The superior catalytic activity of certain embodiments of the electrode provides good sensitivity. The electrode comprises a nanoparticulate catalyst suited to the desired application, for example, nickel, palladium, rhodium, or platinum for a hydrogen sensor. Those skilled in the art will understand that other embodiments of the electrode are useful in sensors for other electrochemically active species, for example, oxygen in a reducing environment. Moreover, some embodiments are useful for detecting electrochemically active species in a liquid phase, for example, in water testing.

In some embodiments, an electrode such as a cathode is formed from a compressed mixture of a supported nanoparticle composition, for example, comprising nanoparticles, fluorocarbon, and carbon. The composition is compressed using any suitable method, for example, on a roller mill under about 10-500 lb/in² (about 70-3500 kPa) pressure, most preferably about 200 lb/in² (about 1400 kPa) pressure. In some preferred embodiments, the composition is compressed in a roller mill of at least about 50 mm under about 1500 lb-force (about 6,600 N). In other embodiments, rollers in a roller mill are adjusted to just touching each other with a zero gap (e.g., “kissing”), and a sheet formed therebetween. In other embodiments, there is a small gap between the rollers, for example, up to about 0.13 mm. As used herein, the term “compressed mixture” refers to a self-adhering, shape-maintaining structure that is not necessarily without voids.

In some embodiments, the compressed mixture is in the form of a sheet or ribbon, which can be used to construct an alkaline fuel cell electrode by pressure lamination to a nickel current collector, or into PEMFC or DMFC cathodes through other processes that are well known to one of ordinary skill in the art. In some embodiments, a free-standing sheet can be made by milling the mixture in a roller mill, or by applying the mixture to roller nips in a roller mill.

In some embodiments, a semipermeable hydrophobic layer or membrane as known in the art, such as one comprising PTFE, is bonded to either or both sides of the electrode, preferably on the side to which the nanoparticulate composition is laminated. The hydrophobic layer allows oxygen to enter the electrode without the aqueous electrolyte escaping.

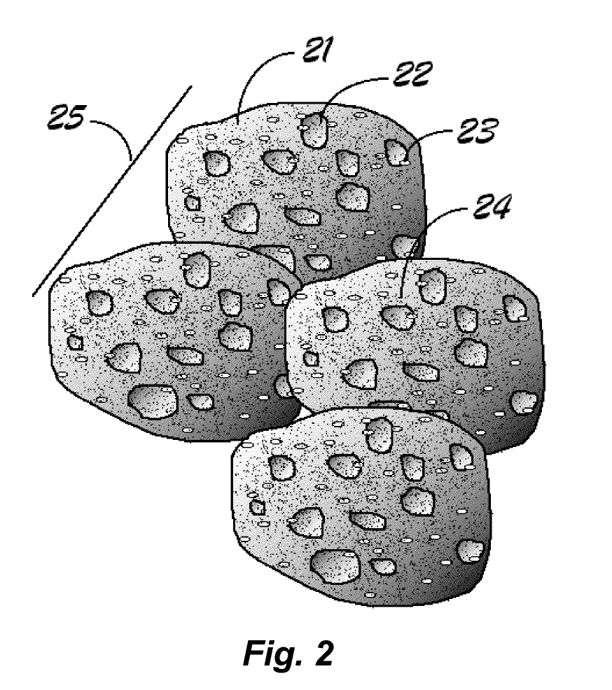

FIG. 2 is a schematic drawing of mixture of materials used to form a cathode, prior to milling according to one embodiment. The following exemplary process illustrates the manufacturer of an embodiment of the cathode mixture 25 in FIG. 2.

In one embodiment, an electrode, for example, a gas diffusion cathode, comprises carbon particles of from about 5 nm to about 1 μm in diameter with high surface area, preferably with a very large internal surface area, for example, Darco® G-60 (American Norit Corp.). The carbon particles are bound together by fibrillated fluorocarbon particles, for example, Teflon®-30b, Teflon® 30N, or Teflon® TE-3857, (DuPont, Wilmington, Del.) or poly(vinylidene fluoride) of from about 1% to about 25% of the total weight of the mixture including binder, support, and nanoparticles. The particle sizes of the fluorocarbon particles are from about 0.3 μm to about 10 μm in some embodiments. The mixture is further blended with catalytic nanoparticles, as described above. The blended mixture, for example, in the form of a milled sheet, is pressed into a metallic current collector, which as discussed above, is generally nickel or noble metals with a large void volume, such as expanded metal or woven wire screen.

Referring to FIG. 2, an activated carbon particle 21 is shown as an irregular ovoid with many deep pockets 22. These carbon particles can have a huge internal porosity, rather like miniature sponges. Also shown in approximate size ratio, are the half-micron particles of PTFE from the Teflon®-30b emulsion 23. The small black dots 24 represent 2 nm to 10 nm nanoparticles. These nanoparticles are believed to adhere to, and to penetrate into the activated carbon particles or be drawn into pores of the activated carbon particles. This mixture 25 is milled to form the free standing sheet as discussed above.

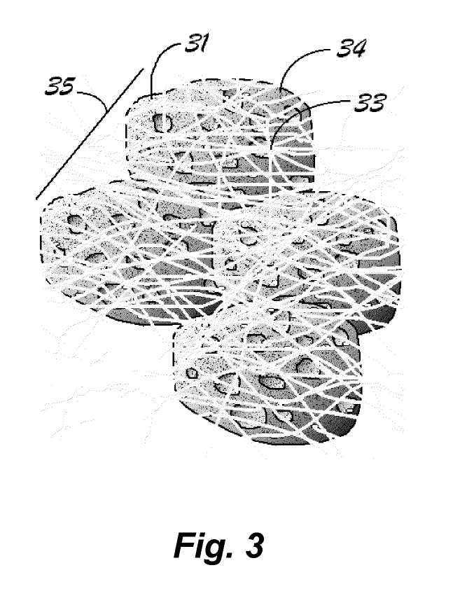

Referring to FIG. 3, after rolling into a free standing sheet, the activated carbon particles 31 are bound together by the now fibrillated PTFE particles of the Teflon®-30b emulsion 33. The tiny black dots 34 represent the 2 nm to 10 nm catalytically active particles, also bound with the fibrillated binder. This matrix 35 is free standing and ready to be laminated to a current collector. This matrix sheet of the nanoparticle composition forms the active component of the cathode. Additionally, an appropriate metallic current collector or conductive carbon sheet can optionally be included, depending on the end product, as is well known to one of ordinary skill in the art.

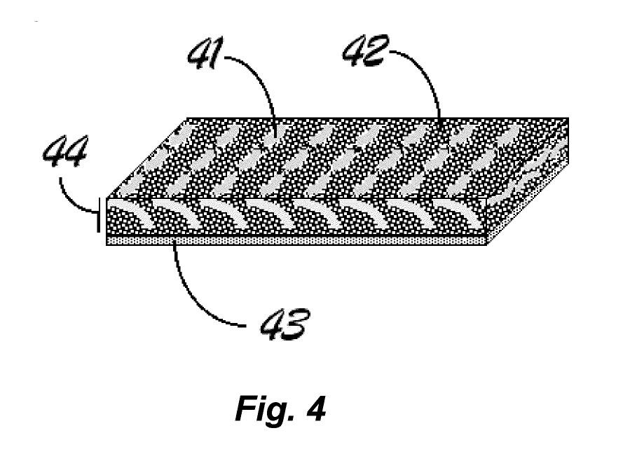

FIG. 4 is a schematic diagram of a cathode structure according to an embodiment of the invention. A nickel current collector 41 is continuous and embedded within the carbon/nanoparticle catalyst/PTFE matrix 42 and 35. For alkaline fuel cells, a PTFE hydrophobic membrane 43 can be pressure laminated to the active body 44, thereby blocking water transfer. The illustrated embodiment is catalytically active and can function as an alkaline fuel cell oxygen reduction electrode. With the lamination of a separator on the opposite side from the PTFE surface, the cathode is useful in metal-air batteries.

The following examples describe the manufacture of particular embodiments of the compositions, electrodes, and devices disclosed herein. Those skilled in the art will understand these descriptions are exemplary and that modifications as to proportions and scale are possible.

### Example 1

### Preparation of a Cathode Mixture

About 400 g to 1500 g distilled water was placed into a large beaker with a volume of about 3 times the water volume. About ⅓ the water weight of activated carbon Darco® G-60 (American Norit Corp.) or equivalent was added to the water. About ⅓ the weight of carbon of potassium permanganate (KMnO₄) was added to the mixture slowly while stirring. The amount of KMnO₄ can range from none to equal to weight of the carbon, resulting in from about 0% to about 15% by weight as manganese (Mn) in the final cathode. The KMnO₄ may be added as dry crystals or as a prepared solution of about 20% KMnO₄ in water. The above components were mixed for at least 20 minutes to allow the KMnO₄ to be reduced to Mn(+2) in situ by the activated carbon. Water was added if the mixture was too viscous until it was easily stirred. From about 0.07 g to about 0.44 g of PTFE suspension (Teflon® 30b, DuPont) per gram of carbon was added while stirring the mixture, resulting in a dry PTFE content of from about 3% w/w to about 25% w/w per total weight of the mixture. Electrodes comprising up to about 50% w/w PTFE are useful in some applications. This mixture was mixed for at least about 30 minutes, which allowed all of the PTFE particles to attach themselves to the carbon particles. The mixture was then filtered in a large Büchner funnel and transferred to a non-corrosive pan. Preferably the thickness of the damp mix was not more than about 5.1 cm (2 inches).

The mixture was then dried in a preheated ventilation oven at 75° C. for at least 24 hours in an open container, then further dried in a preheated oven at 120° C. for 12 hours in an open container. This temperature (120° C.) was not exceeded in these examples. A lid was placed on the drying pan and after cooling below 100° C., the container was sealed in a plastic bag. This material is referred to below as “Teflonated carbon.”

From about 0.01% to about 20% w/w by weight the total weight of the mixture of catalytically active nanoparticles was added to the Teflonated carbon. If more than one mixture was prepared, describe each] As discussed above, the preferred average diameter of the nanoparticles is less than about 10 nm, but particles with average diameters of less than about 50 nm and less than about 100 nm have also been shown to be catalytically active in some embodiments, for example, for metals and alloys of nickel, cobalt and silver. The dried mixture was blended in a very high sheer blender for from about 30 seconds to about 5 minutes.

### Example 2

### Preparation of Electrode Active Layer

The following preparation method was used to prepare an exemplary composition of the electrode active layer 42. (See Table 1, below, Number 9, for example.) The quantities are representative only and the quantities and proportions can be varied.

Distilled water (500 g) was placed into a large (at least about 1.5 liters) beaker. Activated carbon powder (150 g Darco® G-60, American Norit) or equivalent was slowly added to the distilled water, mixing slowly to dampen mixture. Using a propeller type mixer, a stable vortex was established without drawing air into the fluid (i.e., vortex not touching the mixing blade) and mixed for about 20 minutes. Slowly (over about 30 seconds), about 250 grams of a 20% KMnO₄ solution was added to the mixture, and the mixture stirred for 30 minutes. Very slowly (over about 1 minute), 25 cc PTFE suspension (Teflon® 30b DuPont) was added. Stirring was continued for 30 minutes, while maintain a vortex without allowing air to be driven into the fluid. The mixture initially became very viscous, then less so as the PTFE particles adhered to the carbon particles in the mixture. The mixture was filtered in a large Büchner funnel and transferred to a non-corrosive pan. The mixture was dried in a preheated oven at 75° C. for 24 hours in an open container, then further dried in a preheated oven at 120° C. for 12 hours in an open container. A lid was placed on drying pan, and after cooling below 100° C., the container was placed in a sealed plastic bag.

After cooling was complete, about 10% of catalytic nanoparticles by weight of the total mixture, was added. The mixture was dry blended in a very high sheer blender between about 30 seconds to about 5 minutes.

### Example 3

### Methanol Preparation Method of Electrode Active Layer

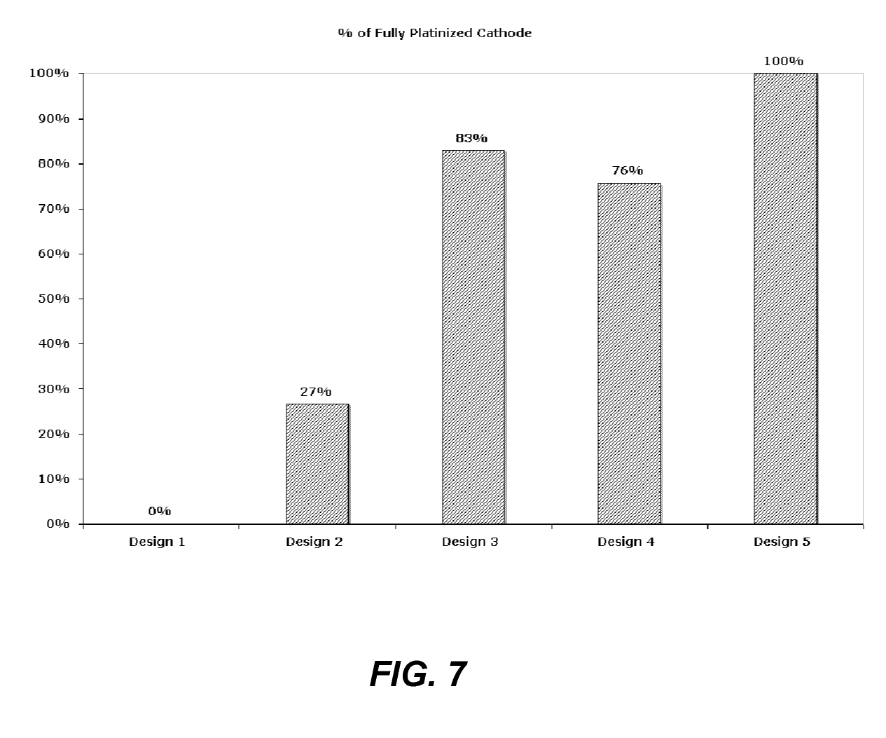

The following methanol preparation method forms an exemplary, preferred composition of the electrode active layer 42. (See FIG. 7.) The quantities are representative only and the quantities and proportions may be varied.

About 500 g distilled water was placed into a large (at least about 1.5 liters) beaker. Activated carbon powder (150 grams, Darco® G-60, American Norit) or equivalent was slowly added to distilled water, mixing slowly to dampen mixture. Using a propeller type mixer, a stable vortex was established without drawing air into the fluid (i.e., the vortex not touching the mixing blade) and mixed for about 20 minutes. A PTFE suspension (25 cc) (Teflon® 30b, DuPont) was very slowly (over about 1 minute) added. Stirring was continued for about 30 minutes, while maintaining the vortex without allowing air to be driven into the fluid. The mixture initially became very viscous, then less so as the Teflon particles adhered to the carbon in the mixture. The mixture was filtered in a large Büchner funnel and transferred to a non-corrosive pan. The mixture was dried in a preheated oven at 110° C. for 24 hours in an open container. A lid was placed on drying pan, and after cooling below 100° C., the container was placed in a sealed plastic bag, and placed under an inert atmosphere, for example, in a chamber filled with nitrogen and/or argon. This material is referred to below as “Teflonated carbon powder.”

In a vial under an inert atmosphere (e.g., nitrogen and/or argon), the nanoparticles, preferably nano-manganese or nano-manganese alloys having an oxide shell, were added to about 3 times their weight in deoxygenated methanol (MeOH), and mixed, forming an “ink” (e.g., a black, substantially opaque liquid). This ink was optionally ultrasonically mixed. The vial was sealed once mixing is complete.

A mixture of 1 part of the dried Teflonated carbon powder and 4 parts MeOH was prepared under an inert atmosphere.

Under an inert atmosphere, a quantity of the Teflonated carbon/MeOH mixture was placed in a clean porcelain bowl and a desired amount of the nanoparticle ink was added, and the mixture mixed for at least about 2 minutes. A typical loading of nanoparticles is from about 5 wt % to about 15 wt % of nMn in the final mixture. The mixture was allowed to stand for about 15 minutes, then removed from the inert atmosphere. The nano catalyst is believed to have been adsorbed into the carbon particles, thereby coating the pores. The bowl containing the mixture was then placed in a well-ventilated, pre-heated 105° C. convection oven until mixture reached 105° C. For a 5 gram sample, this took about 100 minutes. In some embodiments, oxidation of the nanoparticles occurs in this step. For example, for nano manganese powder, the manganese is oxidized in situ to a catalytically active MnOₓ, where x=0 to 2.

An exemplary composition comprises a mixture of 5 grams Teflonated carbon, 0.555 grams of the nano-manganese ink. The mixture was stirred for at least about 2 minutes, dried for 100 minutes at 100° C., covered, and allowed to cool to RT.

This resulting powder was applied substantially uniformly to roller nips of a roller mill to form a free-standing sheet. The PTFE within the mixture fibrillates during milling to form a ribbon of a free-standing sheet during compression of the mixture by the mill.

An electrode was formed from this sheet by laminating to a current collector using a roller mill under about 1500 lb-force (about 6,600 N). In this example, the current collector was a fine mesh nickel screen of about 40×40 mesh or a fine, expanded metal made from a base nickel stock of about 0.1 mm (0.004 inch). A hydrophobic, porous film less than about 0.1 mm (0.008 inches) thick was laminated to one face of the electrode in the roller mill under less than about 1000 lb-force (about 4,400 N). The resulting electrode was useful as a gas diffusion electrode, for example, for metal-air batteries and/or alkaline fuel cells.

### Example 4

### Cathode Performance

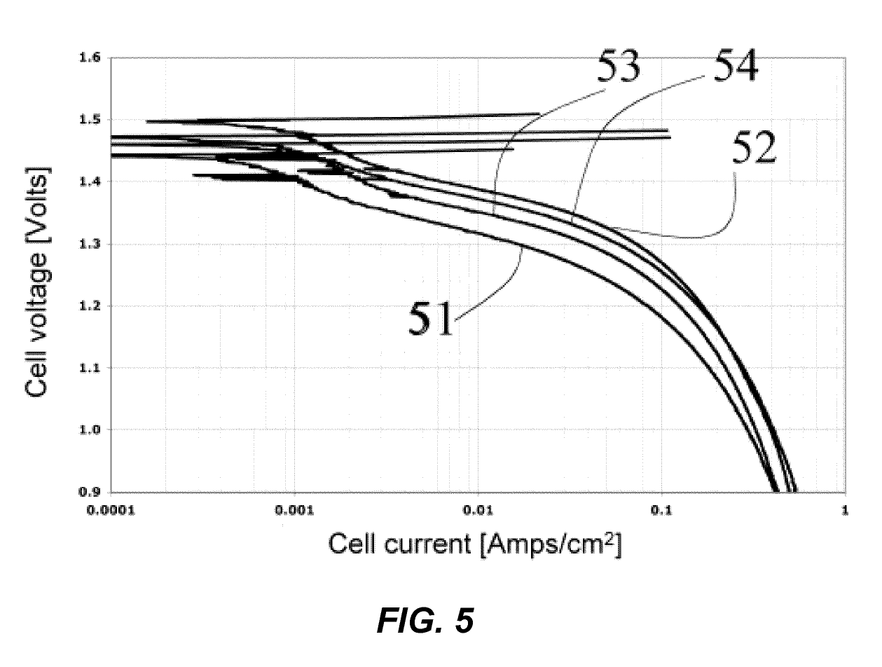

Cathodes were tested using a DSE half-cell apparatus in 33% KOH electrolyte against a zinc reference electrode, using a Solartron SI-1250 Frequency Response Analyzer and SI-1287 Electrochemical Interface and a computer. All testing was done under ambient laboratory conditions. FIG. 5 shows a set of four, cell voltage/current (voltammogram) plots in one graph for comparison. The lowest line 51 is for a baseline cathode with no additional catalyst added (Table 1, entry 30). The voltage/current characteristic shows an inherent catalysis for the activated carbon. For the highest line 52, the cathode contains about 8 mg/cm² of micron-scale powdered platinum (Table 1, entry 1). This cathode contains about 45% by weight platinum, rendering it generally impractical for mass production, but it is intended to serve as a reference. Line number 53 corresponds to a cathode that contains about 5% by weight manganese as MnO or Mn(OH)₂ and represents a cathode similar to those used in metal air batteries (Table 1, entry 14). Line 54 corresponds to an experimental result for a cathode having the same magnesium loading as the cathode represented by line 53, but with 10 wt. % nanoparticles comprising nickel-cobalt alloy catalyst (nNiCo) added, which demonstrates the improved catalytic activity of this nanoparticle catalyst (Table 1, entry 7).

The mid-Tafel plot closed circuit voltages (CCVs) at 10 mA/cm² was chosen as the conditions for routine comparison since this region is predominantly electrochemically driven with little impedance interaction. The cathode is held for 30 minutes at 10 mA/cm² to ensure steady state. Experimentally, this value is stable for over 5 ampere-hours with little degradation.

Table 1, below, provides a summary of experimental data sorted by (CCV) on 10 mA/cm² test. Also tabulated is the loading of platinum or nanoparticle catalyst. The last column expresses the CCV as a percentage of the pure platinum catalyst, deconstructing the activities of nNiCo, nNi and nAg, as well as the augmenting effects of platinum and magnesium base catalysts. All of the nanoparticles comprised an oxide of the metal or metal alloy.

TABLE 1

| | | | | nano/ | 10 | % of |
|---|---|---|---|---|---|---|
| # | Design | Pt/cm² | % Pt | cm² | mA CCV | Pt CCV |
| 1 | Platinum | 7.7 | 100% | | 1.387 | 100% |
| 2 | Platinum | 6.6 | 86% | | 1.387 | 99% |
| 3 | Pt & nNiCo | 3.8 | 57% | 3.0 | 1.380 | 90% |
| 4 | Pt & nNiCo | 2.1 | 32% | 2.6 | 1.374 | 81% |
| 5 | nNiCo/Pt | 0.5 | 8% | 1.8 | 1.373 | 80% |
| 6 | Pt & nNiCo | 1.3 | 19% | 2.7 | 1.368 | 72% |
| 7 | nNiCo | | 0% | 4.2 | 1.368 | 72% |
| 8 | Platinum | 3.8 | 58% | | 1.368 | 72% |
| 9 | KMnO₄ + nNiCo | | 0% | 1.8 | 1.364 | 67% |
| 10 | Pt & nNiCo | 0.6 | 9% | 2.4 | 1.360 | 60% |
| 11 | Pt & nNiCo | 0.4 | 5% | 1.5 | 1.357 | 56% |
| 12 | Pt & nNiCo | 0.4 | 5% | 2.7 | 1.357 | 56% |
| 13 | nNiCo | | 0% | 1.8 | 1.353 | 51% |
| 14 | KMnO₄ | | 0% | | 1.353 | 51% |
| 15 | Platinum | 1.9 | 29% | | 1.352 | 50% |
| 16 | nNiCo | | 0% | 3.9 | 1.352 | 50% |
| 17 | nAg | | 0% | 3.7 | 1.345 | 39% |
| 18 | nNiCo | | 0% | 3.8 | 1.342 | 34% |
| 19 | Platinum | 1.0 | 15% | | 1.342 | 34% |
| 20 | nNiCo | | 0% | 3.9 | 1.341 | 34% |
| 21 | nNi | | 0% | 4.1 | 1.341 | 34% |
| 22 | Platinum | 0.5 | 7% | | 1.339 | 30% |
| 23 | Platinum | 0.3 | 5% | | 1.338 | 29% |
| 24 | Platinum | 0.2 | 4% | | 1.335 | 25% |
| 25 | Pt & nNiCo | 1.0 | 15% | 1.0 | 1.330 | 17% |
| 26 | nNiCo | | 0% | 2.0 | 1.326 | 11% |
| 27 | No added Catalyst | | 0% | | 1.324 | 9% |
| 28 | No added Catalyst | | 0% | | 1.320 | 3% |
| 29 | No added Catalyst | | 0% | | 1.318 | 0% |
| 30 | No added Catalyst | | 0% | | 1.318 | 0% |

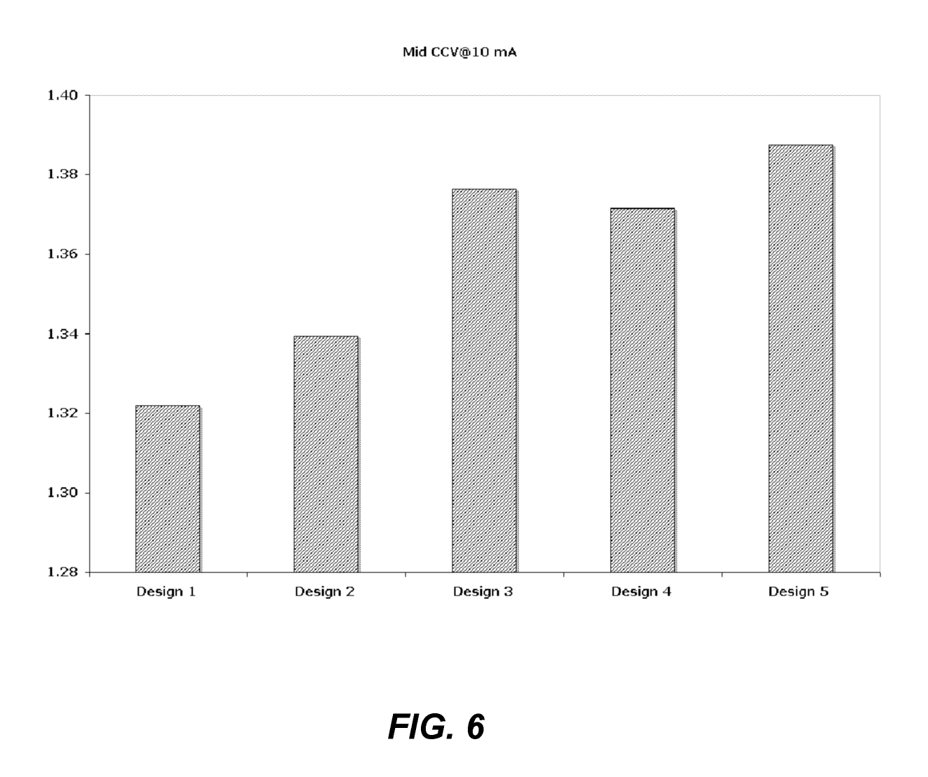

FIG. 6 illustrates the activity of a cathode prepared by the method of Example 1. Electrodes of Designs 3 and 4 comprising nano-manganese with an oxide shell as the catalyst provided superior performance; however, nano-manganese alloys with an oxide shell also gave good performance. The CCV performance of Design 3 provided the best results relative to a platinum-based cathode.

FIG. 7 depicts the data of FIG. 6 a percentage of the reference (platinum catalyst) value. Design 3 prepared by the method of Example 1 with nanoparticles comprising manganese with an oxide shell as the catalyst exhibited 83% of the reference platinum cathode activity.

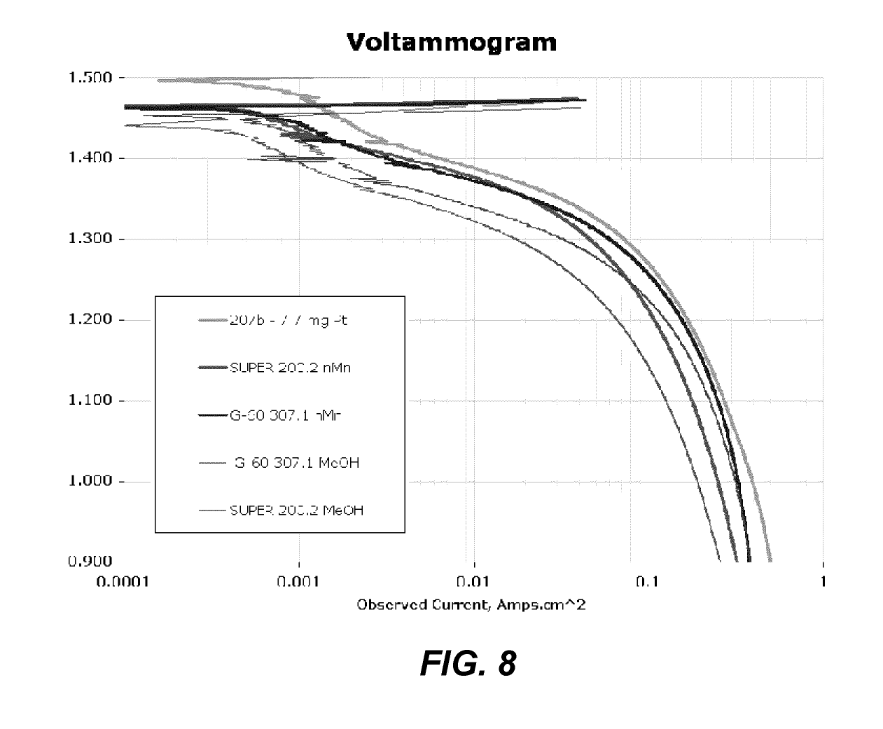

FIG. 8 illustrates the kinetic activity of cathodes prepared by the method of Example 1 using nanoparticles comprising manganese. These cathodes have platinum cathode-like performance.

All references cited herein are expressly incorporated herein by reference in their entireties. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A composition suitable for use in an electrochemical application, the composition comprising a composite of a plurality of metal nanoparticles and a binding material that is substantially inert under conditions of the at least one electrochemical application, wherein the metal nanoparticles are bound together by the binding material in a manner sufficient to leave a substantial portion of surface area of a substantial portion of the nanoparticles exposed, such that the exposed surface area is available for catalyzing a reaction in the at least one electrochemical application.

2. The composition of claim 1, wherein the nanoparticles comprise particles having an effective size less than about 100 nm.

3. The composition of claim 2, wherein the nanoparticles comprise particles having an effective size less than about 50 nm.

4. The composition of claim 3, wherein the nanoparticles comprise particles having an effective size less than about 25 nm.

5. The composition of claim 4, wherein the nanoparticles comprise particles having an effective size less than about 10 nm.

6. The composition of claim 1, wherein at least a portion of the nanoparticles comprises nanoparticles having an oxide shell.

7. The composition of claim 1, wherein the plurality of nanoparticles comprises a metal selected from the group consisting of metals from groups 3-16, lanthanides, combinations thereof, and alloys thereof.

8. The composition of claim 1, wherein the binding material comprises a polymeric material.

9. The composition of claim 8, wherein the polymeric material comprises a fluorocarbon.

10. The composition of claim 8, further comprising a catalyst to enhance the catalytic activity of said composition.

11. An electrochemical component comprising the composition of claim 1.

12. The electrochemical component of claim 11, wherein said component is coupled to a current collector for providing a portion of a circuit that is configured to permit an electrical connection between said component and a second component to transmit current therebetween.

13. An electrode comprising the circuit portion of claim 12, suitable for use in an electrical energy generating device whereby energy may be provided in a controlled fashion.

14. The electrode of claim 13, further comprising a hydrophobic membrane disposed on a face thereof, wherein the membrane is configured to inhibit passage therethrough of water generated by electrochemical reaction of protons and oxygen in the device.

15. The electrode of claim 14, wherein the electrode is a diffusion electrode.
